(19) United States
(12) Patent Application Publication
(10) Pub. No.: US 2026/0251233 A1
(43) Pub. Date: Aug. 27, 2026

(54) FAUCET DEVICE

(71) Applicant: ZEROPLUS TECHNOLOGY CO., LTD., New Taipei City (TW)

(72) Inventor: CHIU-HAO CHENG, New Taipei City (TW)

(73) Assignee: ZEROPLUS TECHNOLOGY CO., LTD., New Taipei City (TW)

(21) Appl. No.: 19/537,526

(22) Filed: Feb. 12, 2026

Related U.S. Application Data
(60) Provisional application No. 63/763,911, filed on Feb. 26, 2025.

(51) Int. Cl. F16K 31/60; E03C 1/04; E03C 1/05

(52) U.S. Cl. CPC F16K 31/602; E03C 1/0401; E03C 1/057

(57) ABSTRACT

A faucet device includes a main body having a base portion and defining a top-bottom direction. An outlet is formed at an end of the main body away from the base portion. A first inlet is formed inside the main body. Amounting groove is formed between the outlet and the first inlet. A through opening communicating with the mounting groove is formed in an outer surface of the main body. A flow control device is mounted in the mounting groove and has a control rod extending out of the through opening. An operation member is engaged with an outer end of the control rod. A surface of the operation member facing the outlet forms a sprayed surface. A projection of the outlet along a top-bottom direction is at least partially located on the sprayed surface.

### CROSS-REFERENCE TO RELATED APPLICATIONS

This application claims benefit of U.S. provisional patent application Ser. No. 63/763,911 filed on February 26, 2025, which is incorporated by reference in its entirety.

### BACKGROUND OF THE INVENTION

### Technical Field

The present invention relates generally to a faucet, and more particularly to a faucet device.

### Description of Related Art

A conventional faucet device is provided with a faucet disposed on a countertop of a sink, a basin, or a bathtub. A middle of the faucet is provided with a pipe. An outer end of the pipe is provided with an outlet. An operation handle configured to control a valve module inside the faucet is disposed adjacent to the faucet. By turning the operation handle to control the valve module, water input into the faucet could pass through the valve module and flow outward from the outlet, thereby allowing a user to obtain water from the outlet for washing hands or other purposes.

The water supply of the conventional faucet device could be turned on and off by controlling the operation handle. However, when the user uses soap or hand wash while washing hands, bubbles might be attached to the operation handle upon the user touching the operation handle. As a result, after washing hands, to clean the operation handle, the user is required to rinse the operation handles by splashing or spraying water onto the operation handle, resulting in inconvenience in use. Water splashes generated by splashing water might cause the countertop around the faucet to become wet, thereby adversely affecting cleanliness of an environment around the faucet.

### BRIEF SUMMARY OF THE INVENTION

In view of the above, the primary objective of the present invention is to provide a faucet device, wherein an outlet of a faucet and an operation member face each other, so that water could be supplied to a user through the outlet and rinse the operation member simultaneously.

The present invention provides a faucet device including a main body, a flow control device, and an operation member. The main body has a base portion; an outlet is formed at an end of the main body away from the base portion. The main body defines a top-bottom direction. A first inlet is formed inside the main body. A mounting groove is formed in a portion of the main body located between the outlet and the first inlet. A through opening is formed in an outer surface of the main body. The through opening communicates with the mounting groove.

The flow control device is mounted in the mounting groove. The flow control device is provided with a control rod located at an axial position of the flow control device. The control rod extends out of the through opening. The control rod is configured to control the flow control device to control opening, closing, and a flow rate of water flowing from the first inlet to the outlet. The operation member is engaged with an outer end of the control rod. A surface of the operation member facing the outlet forms a sprayed surface. A projection of the outlet along the top-bottom direction is at least partially located on the sprayed surface.

With the aforementioned design, the projection of the outlet along the top-bottom direction is at least partially located on the sprayed surface, so that when the user obtains water from the outlet, water flowed out from the outlet rinses the operation member. In this way, after the user operates the operation member to close the outlet, the user is not required to rinse the operation member by splashing water, thereby preventing water splashes generated during splashing water from making the countertop around the faucet device wet, thereby maintaining cleanliness of an environment around the faucet device.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the faucet device according to an embodiment of the present invention;

FIG. 2 is an exploded view of the faucet device according to the embodiment of the present invention;

FIG. 3 is a front view of the faucet device in FIG. 1;

FIG. 4 is a sectional view along the 4-4 line in FIG. 3;

FIG. 5 is a sectional view along the 5-5 line in FIG. 3;

FIG. 6 is a sectional view along the 6-6 line in FIG. 3;

FIG. 7 is a right-side view of the faucet device in FIG. 1; and

FIG. 8 is a sectional view along the 8-8 line in FIG. 7.

### DETAILED DESCRIPTION OF THE INVENTION

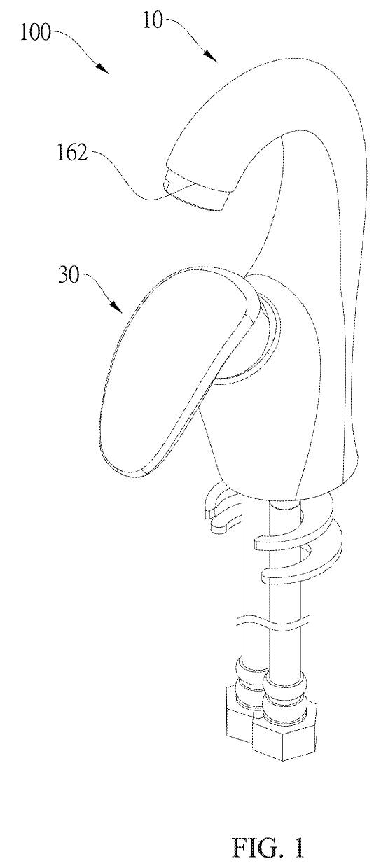

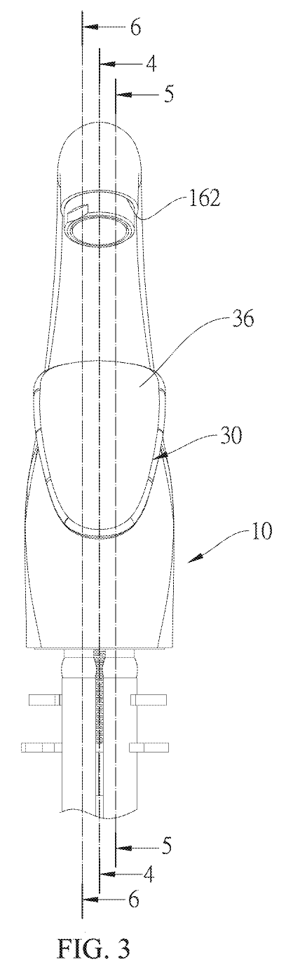

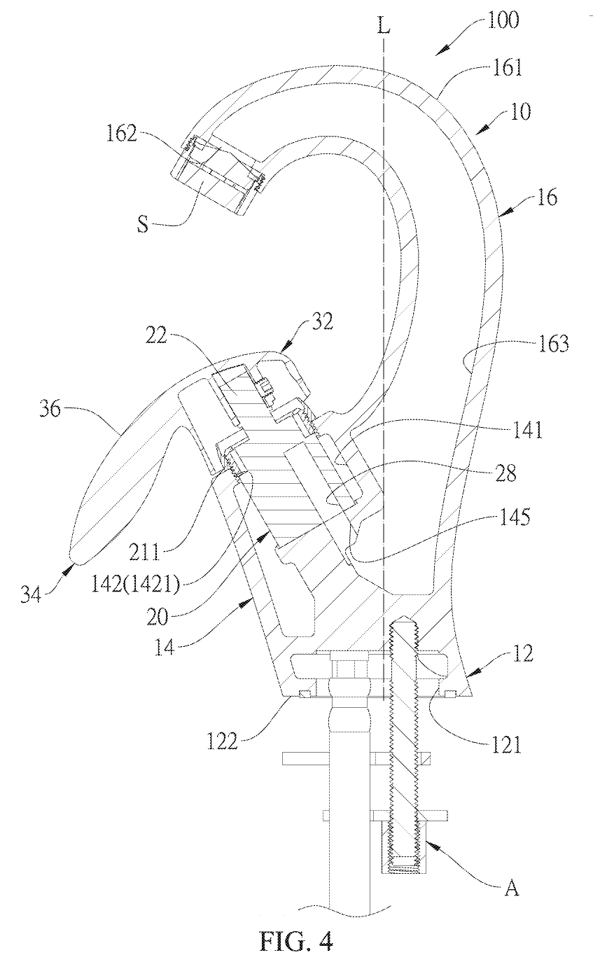

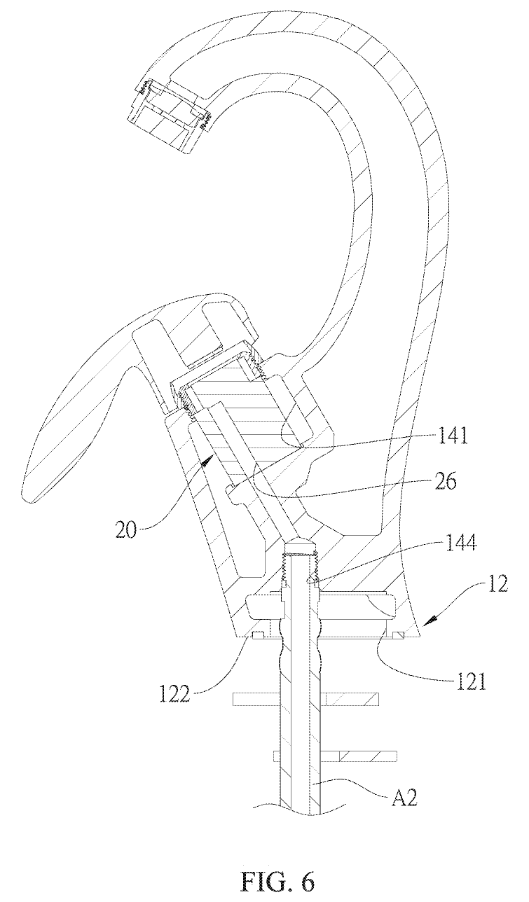

A faucet device 100 according to an embodiment of the present invention is illustrated in FIG. 1 to FIG. 6 and includes a main body 10, a flow control device 20, and an operation member 30. In the following description of the structure, manner of use, and functions of the faucet device 100, the relative positional relationships of the top-bottom direction and the front-rear direction are defined with reference to an orientation of the faucet device 100 in an actual use state.

The main body 10 includes a base portion 12, a seat portion 14, and a pipe portion 16. A cavity 121 is formed inside the base portion 12. A mounting surface 122 is formed on a bottom-end surface of the base portion 12. The mounting surface 122 is configured to be in contact with a countertop of a sink, a basin, or a bathtub where the faucet device 100 is mounted. A normal of the mounting surface 122 is defined as a top-bottom direction L. The seat portion 14 and the pipe portion 16 are connected to the base portion 12 in sequence from bottom to top along the top-bottom direction L.

A mounting groove 141 is formed inside a front-half portion of the seat portion 14. A through opening 142 is formed in a top surface of the front-half portion of the seat portion 14. The through opening 142 communicates with a top-side region of the mounting groove 141 that is away from the base portion 12. The through opening 142 has a circular shape. An inner thread 1421 is formed on an inner peripheral surface of the through opening 142. A first inlet 143, a second inlet 144, and a guiding hole 145 are formed in the seat portion 14. More specifically, the first inlet 143, the second inlet 144, and the guiding hole 145 are formed in a wall surface of a bottom side of the mounting groove 141. A pair of positioning holes 146 is formed on the wall surface of the bottom side of the mounting groove 141. The positioning holes 146 are blind holes. A bottom end of the first inlet 143 communicates with the cavity 121. A top end of the first inlet 143 is formed in the wall surface of the bottom side of the mounting groove 141. A bottom end of the second inlet 144 communicates with the cavity 121. A top end of the second inlet 144 is formed in the wall surface of the bottom side of the mounting groove 141. A top end of the guiding hole 145 is formed in the wall surface of the bottom side of the mounting groove 141. A bottom end of the guiding hole 145 extends downward into a rear-half portion of the seat portion 14.

A bottom end of the pipe portion 16 is connected to the rear-half portion of the seat portion 14. A remaining portion of the pipe portion 16 extends upward from the seat portion 14. A top side of the pipe portion 16 is bent downward and frontward to form a curved section 161. An outer end of the curved section 161 is in an inclined state that faces downward and frontward. An outlet 162 is formed at the outer end of the curved section 161. A water channel 163 is formed inside the pipe portion 16. A bottom end of the water channel 163 extends into the rear-half portion of the seat portion 14. The bottom end of the water channel 163 is connected to the guiding hole 145. A top end of the water channel 163 is connected to the outlet 162. Moreover, an aerator S configured to mix water with air is disposed at the outlet 162.

In the current embodiment, the flow control device 20 is a valve module. The flow control device 20 is mounted in the mounting groove 141. A surface of a bottom side of the flow control device 20 abuts against the wall surface of the bottom side of the mounting groove 141. The flow control device 20 is provided with a control rod 22 located at an axial position of the flow control device 20. The control rod 22 extends out of the through opening 142. A first injection hole 24, a second injection hole 26, and an output port 28 are formed in a surface of a bottom side of the flow control device 20, respectively corresponding to a position of the first inlet 143, a position of the second inlet 144, and a position of the guiding hole 145. A pair of positioning rods 23 is formed on the surface of the bottom side of the flow control device 20 and corresponds to a position of the pair of positioning holes 146. The first injection hole 24 communicates with the first inlet 143. The second injection hole 26 communicates with the second inlet 144. The output port 28 communicates with the guiding hole 145.

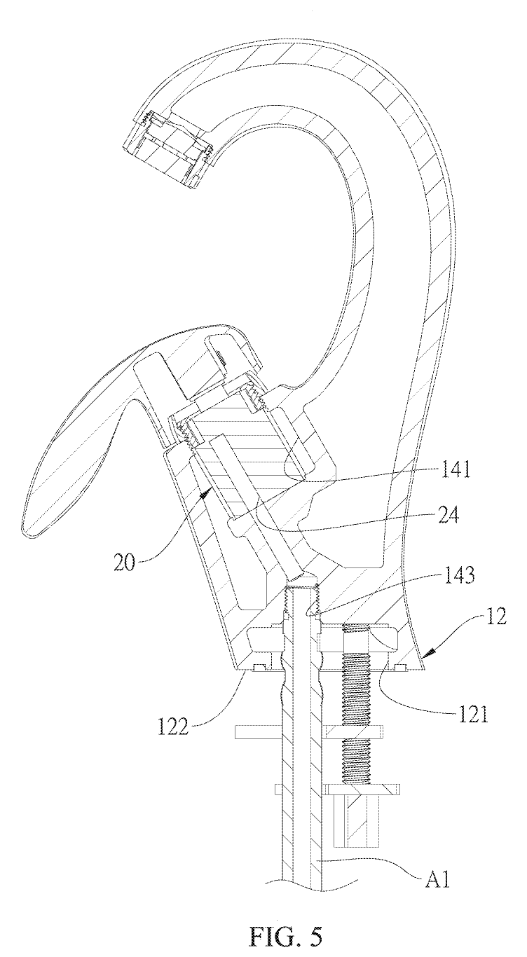

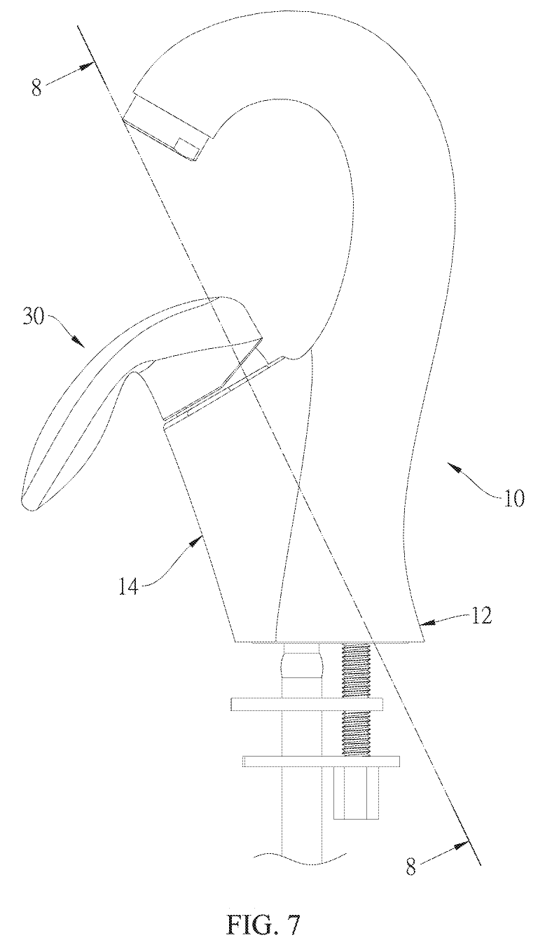

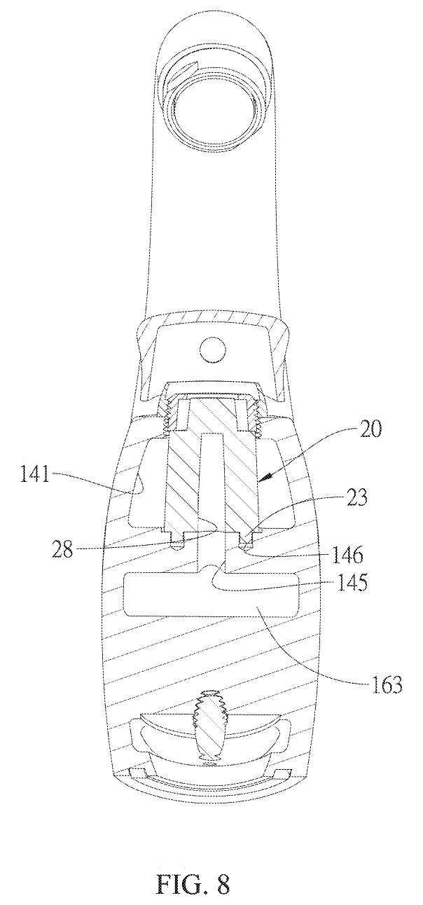

Referring to FIG. 5 to FIG. 8, the pair of positioning rods 23 of the flow control device 20 is inserted into the pair of positioning holes 146, so that the flow control device 20 could not freely rotate relative to the mounting groove 141. Moreover, as the pair of positioning rods 23 is inserted into the pair of positioning holes 146, the first injection hole 24, the second injection hole 26, and the output port 28 of the flow control device 20 could be respectively aligned with the first inlet 143, the second inlet 144, and the guiding hole 145, thereby ensuring that after the flow control device 20 is disposed into the mounting groove 141, the first injection hole 24 actually communicates with the first inlet 143, the second injection hole 26 actually communicates with the second inlet 144, and the output port 28 actually communicates with the guiding hole 145.

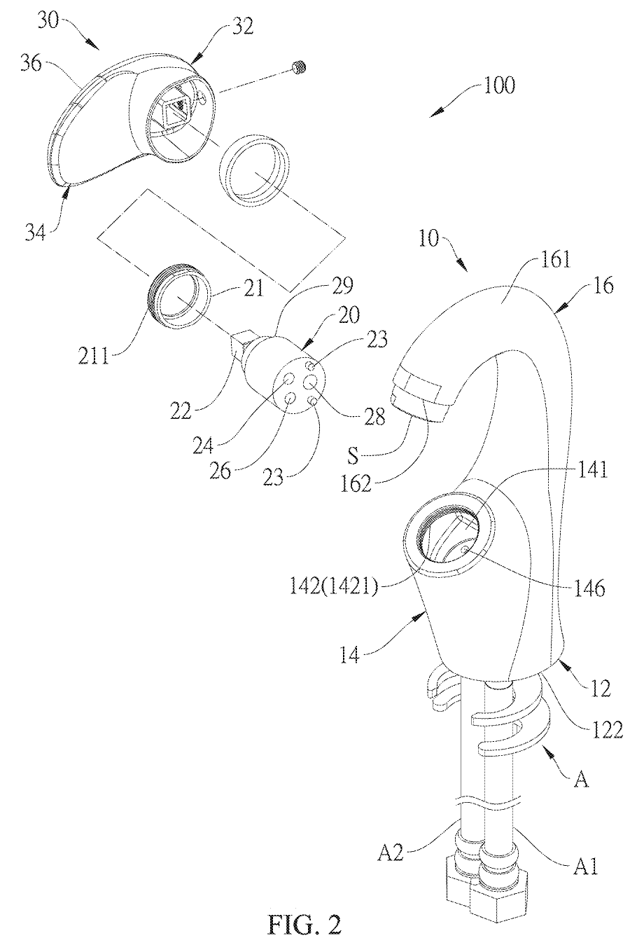

Referring to FIG. 2 to FIG. 6, water flowing into the first injection hole 24 and water flowing into the second injection hole 26 converge in the flow control device 20 and flow out through the output port 28. The control rod 22 is configured to control the flow control device 20 to control opening, closing, and a flow rate of water flowing from the first inlet 143, through the flow control device 20, and to the outlet 162. The control rod 22 could also be configured to control the flow control device 20 to control opening, closing, and a flow rate of water flowing from the second inlet 144, through the flow control device 20, and to the outlet 162. In the current embodiment, water output from the flow control device 20 passes through the output port 28, the guiding hole 145, and the water channel 163 in sequence and then to the outlet 162. A shoulder portion 29 is formed by recessing into a top side of an outer peripheral surface of the flow control device 20. A fixing ring 21 is threadably engaged with the through opening 142 through threading. An outer thread 211 is formed on an outer peripheral surface of the fixing ring 21. The outer thread 211 is engaged with the inner thread 1421. A bottom-end surface of the fixing ring 21 abuts against the shoulder portion 29, so that the fixing ring 21 urges the flow control device 20 downward to fix the flow control device 20 in the mounting groove 141.

The operation member 30 is engaged with an outer end of the control rod 22. The operation member 30 has a connecting portion 32 and a handle 34 connected to the connecting portion 32. The connecting portion 32 is engaged with the outer end of the control rod 22. The handle 34 is integrally connected to the connecting portion 32, and an outer end of the handle 34 extends frontward. The connecting portion 32 and a surface of the handle 34 facing the outlet 162 jointly forms a sprayed surface 36. In the current embodiment, the outlet 162 is located directly above the connecting portion 32 of the operation member 30. A projection of the outlet 162 along the top-bottom direction L is at least partially located on the sprayed surface 36. In the current embodiment, the projection of the outlet 162 along the top-bottom direction L is completely located on the sprayed surface 36, and particularly located on a portion of the sprayed surface 36 corresponding to the connecting portion 32.

When the faucet device 100 according to the embodiment of the present invention is used, the base portion 12 is disposed on a countertop of a sink, a basin, or a bathtub, so that the mounting surface 122 is in contact with the countertop of the sink, the basin, or the bathtub. Then, a top end of a fixation structure A is threadably engaged with the base portion 12 to fix the faucet device 100 to the sink, the basin, or the bathtub, and a top end of a first pipe A1 and a top end of a second pipe A2 extend into the cavity 121, wherein the first pipe A1 and the second pipe A2 are configured to connect to a water source. The top end of the first pipe A1 is engaged with the first inlet 143, and the top end of the second pipe A2 is engaged with the second inlet 144. In the current embodiment, the first pipe A1 is configured to supply cold water to the main body 10, and the second pipe A2 is configured to supply hot water to the main body 10.

When a user is about to obtain water from the main body 10, the user grips the operation member 30 to operate the flow control device 20. By controlling the flow control device 20, cold water from the first pipe A1 and hot water from the second pipe A2 to the main body 10 flow into the flow control device 20, converge in the flow control device 20, and pass through the output port 28, the guiding hole 145, and the water channel 163 to be sprayed outward from the outlet 162. The projection of the outlet 162 along the top-bottom direction L is at least partially located on the sprayed surface 36, so that when the user obtains water from the outlet 162 for washing hands and bubbles of soap or hand wash on the hands are attached to the operation member 30, water coming out from the outlet 162 could allow the user to wash hands for cleaning and remove the bubbles of the soap or hand wash or other dirt attached to the operation member 30. In this way, the user is not required to clean the operation member 30 by splashing or spraying water onto the operation member 30, thereby preventing water splashes generated by splashing water from making the countertop around the faucet device 100 wet. Moreover, the aerator S located at the outlet 162 could mix water discharged from the outlet 162 with external air, so that the discharged water could become finer and smoother and an impart of the discharged water could be reduced, thereby reducing water splashes generated when discharged water from the outlet 162 rinses the operation member 30, and maintaining cleanliness of an environment around the faucet device 100.

In addition to the aforementioned embodiment in which the outlet 162 has a cylindrical shape, the outlet of the present invention could have a flat, straight shape extending horizontally, while still achieving the aforementioned objective. Moreover, in the aforementioned embodiment, the operation member 30 is configured as a handle. In other embodiment, the operation member 30 could be a cross-shaped knob, a column-shaped button, or a column-shaped knob; the operation member 30 having a different shape could also form a sprayed surface 36 on a surface of the operation member 30 facing the outlet 162, so that the projection of the outlet 162 along the top-bottom direction L is at least partially located on the sprayed surface 36. In other embodiments, the projection of the outlet 162 along the top-bottom direction L could be located on a portion of the sprayed surface 36 corresponding to the handle 34 or a portion of the sprayed surface 36 corresponding to a junction of the handle 34 and the connecting portion 32.

In the current embodiment, the first inlet 143, the second inlet 144, and the guiding hole 145 are formed in the wall surface of the bottom side of the mounting groove 141. In other embodiments, the first inlet 143 and the guiding hole 145 could be formed in the wall surface of the bottom side of the mounting groove 141 while the second inlet 144 is omitted; in that case, the flow control device 20 mounted in the mounting groove 141 is not provided with the second injection hole 26; the flow control device 20 is not provided with a function of converging cold water and hot water and outputting the converged water.

Moreover, in the present invention, two side plates facing each other along a left-right direction could be respectively formed on a left side and a right side of the sprayed surface 36. Each of the side plates is basically an elongated plate extending along a front-rear direction. A channel extending along the front-rear direction is formed between the two side plates and the sprayed surface 36. In this way, when water from the outlet 162 reaches the sprayed surface 36, water could converge into the channel and flow frontward, so that water flowing through the channel could rinse the operation member 30 and the channel could guide water from the outlet 162, through the operation member 30, to the user.

It must be pointed out that the embodiments described above are only some preferred embodiments of the present invention. All equivalent structures which employ the concepts disclosed in this specification and the appended claims should fall within the scope of the present invention.

What is claimed is:

1. A faucet device, comprising a main body, a flow control device, and an operation member, wherein:
the main body has a base portion; an outlet is formed at an end of the main body away from the base portion; the main body defines a top-bottom direction; a first inlet is formed inside the main body; a mounting groove is formed in a portion of the main body located between the outlet and the first inlet; a through opening is formed in an outer surface of the main body; the through opening communicates with the mounting groove;
the flow control device is mounted in the mounting groove; the flow control device is provided with a control rod located at an axial position of the flow control device; the control rod extends out of the through opening; the control rod is configured to control the flow control device to control opening, closing, and a flow rate of water flowing from the first inlet to the outlet;
the operation member is engaged with an outer end of the control rod; a surface of the operation member facing the outlet forms a sprayed surface; a projection of the outlet along the top-bottom direction is at least partially located on the sprayed surface.

2. The faucet device as claimed in claim 1, wherein a cavity is formed inside the base portion; a mounting surface is formed on the base portion; a normal of the mounting surface is defined as the top-bottom direction; an end of the first inlet communicates with the cavity.

3. The faucet device as claimed in claim 1, wherein the operation member has a connecting portion and a handle connected to the connecting portion; the connecting portion is engaged with the outer end of the control rod; the sprayed surface is formed on the connecting portion and a surface of the handle facing the outlet.

4. The faucet device as claimed in claim 3, wherein two sides plates facing each other are respectively formed on two sides of the sprayed surface; a channel is formed between the two side plates and the sprayed surface.

5. The faucet device as claimed in claim 2, wherein the outlet is located directly above the operation member; the through opening communicates with a top-side region of the mounting groove away from the base portion; another end of the first inlet is formed in a wall surface of the mounting groove; a guiding hole is formed in the wall surface of the mounting groove; the guiding hole communicates with the outlet; the flow control device is a valve module; a first injection hole and an output port are formed in the flow control device; the first injection hole communicates with the first inlet; the output port communicates with the guiding hole.

6. The faucet device as claimed in claim 5, wherein the another end of the first inlet is formed in a wall surface of a bottom side of the mounting groove; the guiding hole is formed in the wall surface of the bottom side of the mounting groove; a second inlet is formed in the wall surface of the bottom side of the mounting groove; a bottom end of the second inlet communicates with the cavity; a surface of a bottom side of the flow control device abuts against the wall surface of the bottom side of the mounting groove; the first injection hole and the output port are formed in the surface of the bottom side of the flow control device; a second injection hole is formed in the surface of the bottom side of the flow control device; the second injection hole communicates with the second inlet; water flowing into the first injection hole and water flowing into the second injection hole converge in the flow control device and flow out through the output port.

7. The faucet device as claimed in claim 6, wherein the through opening has a circular shape; an inner thread is formed on an inner peripheral surface of the through opening; a shoulder portion is formed by recessing into a top side of an outer peripheral surface of the flow control device; a fixing ring is threadably engaged with the through opening; an outer thread is formed on an outer peripheral surface of the fixing ring; the outer thread is engaged with the inner thread; a bottom-end surface of the fixing ring abuts against the shoulder portion to fix the flow control device in the mounting groove.

8. The faucet device as claimed in claim 6, wherein a pair of positioning holes is formed on the wall surface of the bottom side of the mounting groove; a pair of positioning rods is formed on the surface of the bottom side of the flow control device; the pair of positioning rods is inserted into the pair of positioning holes, thereby fixing a position of the surface of the bottom side of the flow control device abutting against the wall surface of the bottom side of the mounting groove.

9. The faucet device as claimed in claim 5, wherein the main body is connected to a seat portion and a pipe portion in sequence from bottom to top along the top-bottom direction; the through opening is formed in a top surface of a front-half portion of the seat portion; the mounting groove is formed inside the front-half portion of the seat portion; a bottom end of the pipe portion is connected to a rear-half portion of the seat portion; a curved section is formed on a top side of the pipe portion; the outlet is formed at an outer end of the curved section; a water channel is formed inside the pipe portion; an end of the water channel is connected to the guiding hole; another end of the water channel is connected to the outlet.

10. The faucet device as claimed in claim 1, wherein an aerator configured to mix water with air is disposed at the outlet.
